(19) United States
(12) Patent Application Publication
(10) Pub. No.: US 2012/0141828 A1
(43) Pub. Date: Jun. 7, 2012

(54) FILM STRUCTURE AND PORTABLE ELECTRONIC DEVICE EMPLOYING SAME

(75) Inventors: CHAO-TSANG WEI, Tu-Cheng (TW); GA-LANE CHEN, Santa Clara, CA (US)

(73) Assignee: HON HAI PRECISION INDUSTRY CO., LTD., Tu-Cheng (TW)

(21) Appl. No.: 13/026,276

(22) Filed: Feb. 13, 2011

(30) Foreign Application Priority Data
Dec. 6, 2010 (TW) 99142476

(51) Int. Cl. B32B 15/04

(52) U.S. Cl. 428/632; 428/621

(57) ABSTRACT

A film structure includes a metal substrate, a metal film formed on the metal substrate, an insulating transparent optical film formed on the metal film. The metal film eliminates an interference color of the optical film so that the color of the film structure is substantially the same as the metal substrate.

### BACKGROUND

1. Technical Field

The present disclosure relates to a film structure and a portable electronic device employing the film structure.

2. Description of Related Art

Antennas are accommodated in the shells of many cell phones. The human body is a conductor, because of this, if the shell is made of metal, the metallic shell is grounded via the user when the cell phone is being held. In this case, the metallic shell may block the radio waves, generating a weak signal from the cell phone.

Therefore, it is desirable to provide a film structure and a portable electronic device, which can overcome the above-mentioned limitations.

### BRIEF DESCRIPTION OF THE DRAWINGS

FIG. 1 is a cross-sectional view of a film structure according to a first embodiment.

FIG. 2 is a perspective view of a portable electronic device employing the film structure of FIG. 1.

### DETAILED DESCRIPTION

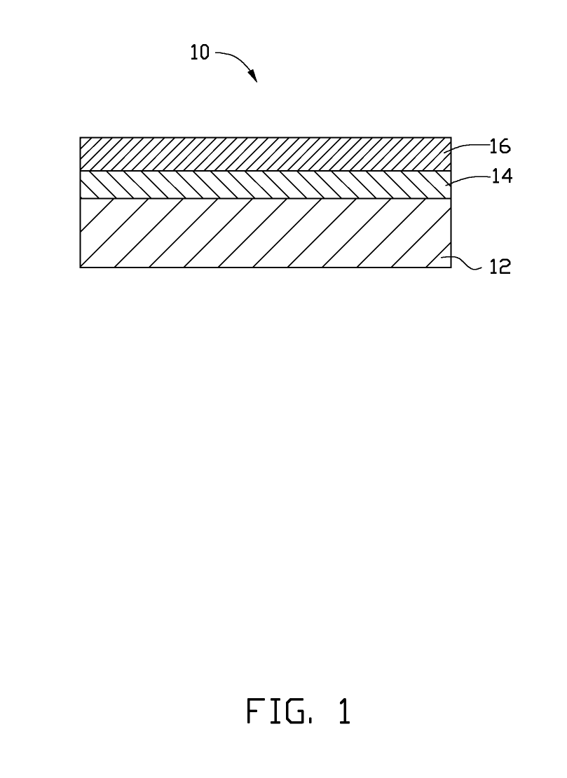

Referring to FIG. 1, a film structure 10 according to a first embodiment includes a metal substrate 12, a metal film 14, and an optical film 16. The metal film 14 is formed on a surface of the metal substrate 12, and the optical film 16 is positioned on a surface of the metal film 14.

The metal substrate 12 may be made of pure metal, such as copper, chromium, gold, or silver. The metal substrate 12 may also be made of alloy, for example, stainless steel, or aluminum alloy. In the present embodiment, the metal substrate 12 is made of stainless steel SUB 304.

The metal film 14 is made of pure metal, such as, aluminum, copper, chromium, gold, or silver. The metal film 14 may be formed by sputtering. A thickness of the metal film may be in an approximate range from about 2 nm to about 7 nm.

The optical film 16 is made of transparent insulating material, such as titanium dioxide, tantalum pentoxide, niobium pentoxide, silicon dioxide, aluminum oxide, or zirconium dioxide. In the present embodiment, the optical film is made of silicon dioxide. The optical film 16 may be formed by sputtering. A thickness of the optical film may be in an approximate range from about 2100 nm to about 2300 nm.

The metal film 14 eliminates an interference color of the optical film 16 caused by thin-film interference. That is, the thicknesses of the metal film 14 and the optical film 16 are adjusted based on the thin-film interference so that the color of the film structure 10 is substantially the same as the metal substrate 12.

In the present embodiment, a Lab color of the metal substrate 12 is (85.75, 2.67, 6.5), and the thickness of the metal substrate 12 is about 2200 nm. The thickness of the metal film 14 is about 3 nm. The thickness of the optical film 16 is about 2200 nm. The Lab color of the film structure 10 is (85.37, 2.65, 6.57). The color of the film structure 10 is substantially the same as the metal substrate 12.

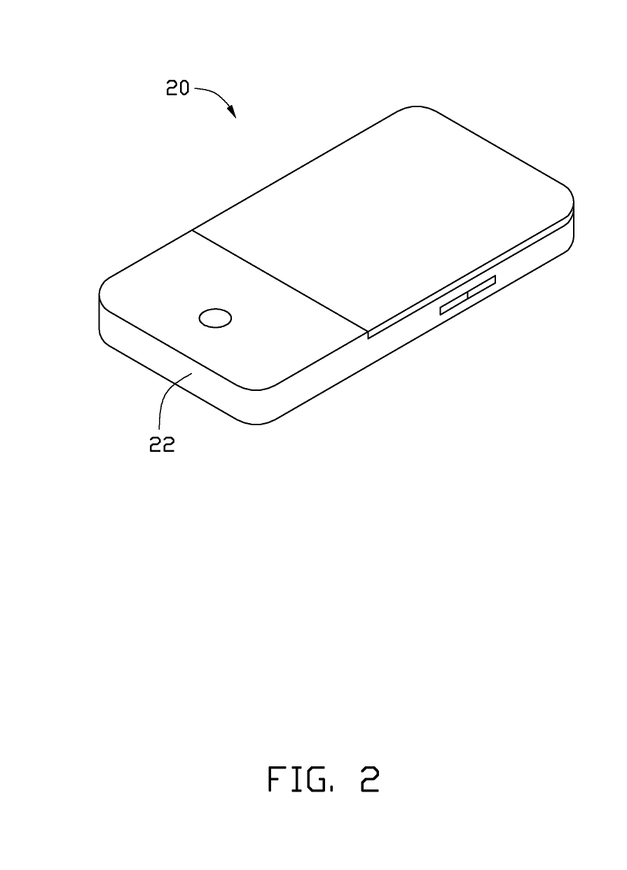

Referring to FIG. 2, a portable electronic device 20 includes a shell 22. In the present embodiment, the portable electronic device 20 is a cell phone. The shell 22 is made of the film structure 10 of FIG. 1.

In the present embodiment, because the optical film 16 is insulating, the metal substrate 12 will not block radio waves when the user holds the portable electronic device 20. Since the metal film eliminates the interference color of the optical film 16, the shell 22 has a metallic appearance.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A film structure comprising:
a metal substrate;
a metal film formed on the metal substrate;
an insulating transparent optical film formed on the metal film, the metal film being configured for eliminating an interference color of the optical film so that a color of the film structure is substantially the same as that of the metal substrate.

2. The film structure of claim 1, wherein a material of the metal film is selected from the group consisting of aluminum, copper, chromium, gold, and silver.

3. The film structure of claim 1, wherein a material of the optical film is selected from the group consisting of titanium dioxide, tantalum pentoxide, niobium pentoxide, silicon dioxide, aluminum oxide, and zirconium dioxide.

4. The film structure of claim 1, wherein a thickness of the optical film is in an approximate range from 2100 nm to 2300 nm.

5. The film structure of claim 1, wherein a thickness of the metal film is in an approximate range from 2 nm to 7 nm.

6. The film structure of claim 1, wherein a material of the substrate is selected from the group consisting of copper, chromium, gold, silver, and any combination alloy thereof.

7. The film structure of claim 6, wherein the metal substrate is made of stainless steel, and Lab color coordinates of the metal substrate is (85.75, 2.67, 6.5).

8. The film structure of claim 7, wherein the metal film consists of aluminum.

9. The film structure of claim 8, wherein the optical film consists of silicon dioxide.

10. The film structure of claim 9, wherein a thickness of the metal film is about 3 nm.

11. The film structure of claim 10, wherein a thickness of the optical film is about 2200 nm.

12. A portable electronic device including a shell, the shell made of a film structure, the film structure comprising:
a metal substrate;
a metal film formed on the metal substrate;
an insulating transparent optical film formed on the metal film, the metal film being configured for eliminating an interference color of the optical film so that a color of the film structure is substantially the same as that of the metal substrate.

13. The portable electronic device of claim 12, wherein a material of the metal film is selected from the group consisting of aluminum, copper, chromium, gold, and silver.

14. The portable electronic device of claim 12, wherein a material of the optical film is selected from the group consisting of titanium dioxide, tantalum pentoxide, niobium pentoxide, silicon dioxide, aluminum oxide, and zirconium dioxide.

15. The portable electronic device of claim 12, wherein a thickness of the optical film is in an approximate range from 2100 nm to 2300 nm.

16. The portable electronic device of claim 15, wherein a thickness of the metal film is in an approximate range from 2 nm to 7 nm.

17. The portable electronic device of claim 12, wherein a material of the substrate is selected from the group consisting of copper, chromium, gold, silver, and any combination alloy thereof.
